(19) United States
(12) Patent Application Publication
(10) Pub. No.: US 2026/0116447 A1
(43) Pub. Date: Apr. 30, 2026

(54) EXPANDABLE FOLDING CART

(71) Applicant: Zhejiang Pride Leisure Products Co,. Ltd., Jinhua (CN)

(72) Inventor: Benlong SUN, Jinhua (CN)

(21) Appl. No.: 19/366,738

(22) Filed: Oct. 23, 2025

(30) Foreign Application Priority Data
Oct. 25, 2024 (CN) 202411510309.5

(51) Int. Cl. B62B 3/02; B62B 5/00

(52) U.S. Cl. CPC B62B 3/02; B62B 5/0013

(57) ABSTRACT

An expandable folding cart having four side columns, a top block being fixedly arranged at an upper end of each side column; wheel assemblies detachably mounted at the bottom of the side columns; an external assembly detachably mounted on the side columns; and a table board assembly mounted on the top blocks. In the expandable folding cart of the present disclosure, due to the arrangement of the external assembly, an awning can be externally connected to the side columns of the cart. Moreover, due to arrangement of the expansion assembly and the table board assembly, the loading capacity of the cart is improved, so as to facilitate the operation of workers with the table boards and prevent smaller objects from falling, thereby realizing use of the cart in different scenarios.

### BACKGROUND OF THE INVENTION

### 1. Technical Field

The present disclosure relates to the technical field of carts and, in particular, to an expandable folding cart.

### 2. Description of Related Art

A cart is a handling vehicle that is pushed and pulled by man, it is the ancestor of all vehicles. Although the cart handling technology continues to develop, the cart is still used as an indispensable handling tool. The cart is widely used in production and life because it features low price, easy maintenance, easy operation and light weight, and can work in places where motor vehicles do not work. The cart is handy for carrying light items over short distances.

For example, patent CN117842156B specifically discloses a folding structure for carts. The patent provides an adjusting mechanism by which the width of a cart can be conveniently adjusted when the cart travels in a narrow roadway, so that the cart can easily pass through. Moreover, the adjusting mechanism has a locking function to adapt to different roadway widths.

However, when in use, the cart often needs to be used in some special occasions, such as a temporary sales point, and in this case, a canopy is needed to block the sun or prevent rain, and the temporary addition of the canopy often requires workers to use additional rods to fix the canopy, thereby increasing the difficulty of on-site operation. So it is desirable to provide an expandable cart to solve the above problems.

It should be noted that the above information disclosed in the Background is used only to understand the background of the concept of the present disclosure, and as such, it may contain information that does not constitute prior art.

### BRIEF SUMMARY OF THE INVENTION

Based on the above problems existing in the prior art, the problem to be solved by the present disclosure is: to provide an expandable folding cart to solve the problem that the existing cart is difficultly expanded.

The technical solutions adopted by the present disclosure to solve its technical problems are as follows: An expandable folding cart, characterized by comprising: four side columns, a top block being fixedly arranged at an upper end of each side column, a middle block being slidably arranged at a middle part of each side column; upper side rods hinged to the top blocks; lower side rods hinged to the middle blocks, the lower side rods being hinged to the upper side rods in the middle; middle rod groups, each middle rod group comprising two mutually hinged middle rods, the middle rod groups being respectively hinged to the upper side rods and the lower side rods, the two middle rods being hinged in the middle and forming a second hinged point; bottom left blocks hinged to the bottom of the side columns on one side; bottom right blocks hinged to the bottom of the side columns on the other side; two bottom rod groups hinged to the bottom left blocks and the bottom right blocks respectively, the other ends of the bottom rod groups being hinged to bottom side blocks; wheel assemblies detachably mounted at the bottom of the side columns; tie rod assemblies mounted between the bottom side blocks and the second hinged points, each tie rod assembly comprising an upper tie rod fixedly mounted at the second hinged point and a lower tie rod fixedly mounted at the bottom side block, the upper tie rod and the lower tie rod being vertically arranged, the upper tie rod being internally provided with a tie rod groove with an open bottom, the lower tie rod being provided with a waist groove in a vertical direction, a pin being fixedly mounted on the upper tie rod.

An expandable folding cart, characterized by comprising: four side columns, a top block being fixedly arranged at an upper end of each side column, a middle block being slidably arranged at a middle part of each side column; upper side rods hinged to the top blocks; lower side rods hinged to the middle blocks, the lower side rods and the upper side rods being hinged to each other in the middle; middle rod groups, each middle rod group comprising two mutually hinged middle rods, the middle rod groups being respectively hinged to the upper side rods and the lower side rods, the two middle rods being hinged in the middle and forming a second hinged point; bottom left blocks hinged to the bottom of the side columns on one side; bottom right blocks hinged to the bottom of the side columns on the other side; two bottom rod groups hinged to the bottom left blocks and the bottom right blocks respectively, the other ends of the bottom rod groups being hinged to bottom side blocks; wheel assemblies detachably mounted at the bottom of the side columns; tie rod assemblies mounted between the bottom side blocks and the second hinged points, each tie rod assembly comprising a single tie rod arranged between the second hinged point and the bottom side block, an upper end of the single tie rod being provided with a long waist groove, a spring pin being fitted at the second hinged point.

Further, an external assembly is arranged at the upper ends of the side columns and comprises external collars arranged on the side columns, and each external collar is provided with an arc hoop; each external collar is vertically provided with a through rod groove in which an external rod is inserted slidably, an external groove is formed in a side of each external collar, the external grooves are connected with the rod grooves, a button is turnably arranged in each external groove, and torsion springs are arranged between the buttons and the external grooves; an external connecting block is sleeved on the top of each external rod, an external stick is inserted in each external connecting block, and an external awning is mounted on the external sticks; long connecting rods and short connecting rods are inserted in the external connecting blocks.

Further, each of the wheel assembly comprises a lower inner rod mounted at the bottom of the side column, a matching groove which goes through at the bottom is formed in the interior of the lower inner rod in a lengthwise direction, the matching groove is configured as a square, and an insert rod is slidably arranged in the interior of the matching groove; a wheel frame is mounted at the bottom of the insert rod by means of a bearing, and a wheel is mounted on the wheel frame.

Further, the lower inner rod is provided with an insert groove at an upper end of the matching groove, the insert groove is open on a side, an insert block is inserted in the interior of the insert groove, a horizontal chute is arranged at an upper end of the insert groove, and a boss is arranged on a side of the insert block; a hole is formed in a side of the side column, a receiving groove is formed at the bottom of the insert block, an elastomer is mounted between the insert block and the insert groove, the elastomer is adapted to pushing the insert block to protrude the hole in an initial state, and the elastomer, when pressed, is adapted to driving the insert block to slide into the interior of the hole; a receiving groove is formed at the bottom of the insert block, an upper end of the insert rod is provided with a plug, the plug is adapted to the receiving groove, and a step is arranged at the bottom of the receiving groove.

Further, an expansion assembly is arranged at the upper ends of the side columns, the expansion assembly comprises expansion rods slidably arranged in the interior of the side columns, a limit rod is mounted at a lower end of each expansion rod, and a spring is mounted on the limit rod and an upper end of the lower inner rod; a plurality of guide blocks are arranged uniformly at the bottom of each limit rod in a circumferential direction, a plurality of convex blocks are uniformly arranged in the interior of each side column in a circumferential direction, a plurality of guide grooves are formed between the plurality of convex blocks, and the guide grooves are matched with the guide blocks; a limit groove is formed at the bottom of a convex block, and the limit rod is fixedly provided with a limit portion arranged above the guide block and the limit portion is matched with the limit groove.

Further, a canopy assembly is arranged at the top of the expansion rods, the canopy assembly comprises connecting sleeves sleeved on the top of the expansion rods, and each of the four connecting sleeves is hinged to a canopy rod, and the other ends of the four canopy rods are jointly hinged to a canopy connecting block.

Further, an awning assembly is arranged at the top of the expansion rods, the awning assembly comprises extension rods sleeved on the expansion rods, an awning connecting block is sleeved at the top of each extension rod and has three connecting ends, wherein an awning stick is inserted at the outer one of the connecting ends, and an awning is mounted on the awning sticks; a long awning rod and a short awning rod are inserted at the other two connecting ends, and the long awning rod and the short awning rod are configured to connect and fix the four connecting ends.

Further, an extension assembly is mounted on the bottom left blocks, the extension assembly comprises cross bars hinged to the bottom left blocks, the cross bars are arranged in a direction perpendicular to an advancing direction of the cart, and the two cross bars are jointly hinged to a cross block therebetween; extension rods are hinged to the bottom left blocks in the advancing direction of the cart and adopted to rotating in a vertical direction; an end block is arranged at an end of each extension rod, an extension block is slidably arranged at the middle position on each extension rod, first folding rods are hinged to the end blocks, second folding rods are hinged to the extension blocks, the two first folding rods are hinged to each other at the other end, and the first folding rods and the second folding rods are hinged to each other in the middle.

Further, a table board assembly is mounted on the top blocks, the table board assembly comprises table board joints fastened to the top blocks, an upper end of each table board joint is provided with a ring, and table rods are inserted in the rings; a plurality of catchers are uniformly arranged on each table rod in a lengthwise direction, and a table board is fastened in each catcher; a side of each table board is fitted in a side sleeve, each side sleeve is provided with a side plate away from the table board, and the side plates are hinged to each other.

The beneficial effects of the present disclosure are as follows: The expandable cart provided by the present disclosure has the following beneficial effects:
1. Due to the arrangement of the external assembly, an awning can be externally connected to the side columns of the cart. Moreover, due to arrangement of the expansion assembly and the table board assembly, the loading capacity of the cart is increased, so as to facilitate the operation of workers with the table boards and prevent smaller objects from falling, thereby realizing use of the cart in different scenarios.
2. Due to the arrangement of the extension assembly that can be folded and unfolded, the cart can be easily folded and stored, and can be extended in the lengthwise direction to facilitate the carriage of long objects.
3. Due to the arrangement of the wheel assemblies, the wheels can be easily disassembled from the cart, so as to achieve the fast disassembly of the wheels. Moreover, the cart can be folded into a smaller size, thereby realizing a smaller packaging size of the cart.

In addition to the objectives, features and advantages described above, the present disclosure also has other objectives, features and advantages. The present disclosure will be further described in detail with reference to the accompanying drawings below.

### BRIEF DESCRIPTION OF THE SEVERAL VIEWS OF THE DRAWINGS

The drawings of the specification, forming part of the present disclosures, are used to provide further understanding of the present disclosure, and illustrative embodiments of the present disclosure and their descriptions are used to explain the present disclosure and do not constitute undue qualification of the present disclosure. In the drawings:

FIG. 1 is an overall schematic diagram of an expandable folding cart in the present disclosure;

FIG. 2 is another overall schematic diagram of an expandable folding cart in the present disclosure;

FIG. 3 is yet another overall schematic diagram of an expandable folding cart in the present disclosure;

FIG. 4 is still another overall schematic diagram of an expandable folding cart in the present disclosure;

FIG. 5 is a partial structural diagram of part Ain FIG. 3;

FIG. 6 is a partial structural diagram of a lower inner rod and an insert block in FIG. 5;

FIG. 7 is a partial structural diagram of part B in FIG. 3;

FIG. 8 is a partial structural diagram of part C in FIG. 3;

FIG. 9 is a partial structural diagram of an expansion assembly in FIG. 4;

FIG. 10 is an internal structural diagram of a portion where a side column and the expansion assembly are matched in FIG. 5;

FIG. 11 is an overall schematic diagram of an expanded canopy of an expandable folding cart in the present disclosure;

FIG. 12 is an overall schematic diagram of an expanded awning of an expandable folding cart in the present disclosure;

FIG. 13 is an overall schematic diagram of an expandable folding cart in the present disclosure opened from the back;

FIG. 14 is an overall schematic diagram of an expandable folding cart in the present disclosure with an expanded table board and an external awning;

FIG. 15 is an overall schematic diagram of an external awning of an expandable folding cart in the present disclosure;

FIG. 16 is a partial structural diagram of part D in FIG. 15;

FIG. 17 is an overall schematic diagram of an expanded table board of an expandable folding cart in the present disclosure; and

FIG. 18 is a partial structural diagram of part E in FIG. 17.

### REFERENCE NUMERALS

1. frame assembly; 11. upper side rod; 12. lower side rod; 13. side upper rod; side lower rod; 15. top block; 16. middle block; 17. bottom left block; 18. bottom right block; 19. side column; 191. hole; 192. guide groove; 193. limit groove; 110. bottom middle block; 111. bottom side rod; 112. bottom middle rod; 113. bottom side block; 114. middle rod;
2. tie rod assembly; 21. upper tie rod; 22. lower tie rod; 23. single tie rod; 24. long waist groove;
3. wheel assembly; 31. wheel; 32. wheel carrier; 33. insert rod; 34. plug; 35. lower inner rod; 351. chute; 352. insert groove; 353. matching groove; 36. insert block; 361. boss; 362. receiving groove;
4. handle assembly; 41. hinging block; 42. connecting rod; 43. lower handle; 431. fixing hole; 44. upper handle; 441. elastic sheet; 45. grip; 46. junction block;
5. expansion assembly; 51. press head; 52. fastening block; 53. expansion rod; 531. fastening groove; 54. limit rod; 541. guide block; 542. limit portion; 56, spring;
6. canopy assembly; 61. connecting sleeve; 62 canopy rod; 63. canopy connecting block;
7. awning assembly; 71. awning; 72. awning stick; 73. extension rod; 74. awning connecting block; 75. long awning rod; short awning rod;
8. extension assembly; 81. cross bar; 82. cross block; 83. extension rod; 84. extension block; 86. end block; 87. first folding rod; 88. second folding rod;
9. external assembly; 91. external awning; 92. external rod; 93. long connecting rod; 94. short connecting rod; 95. external connecting block; 96. external stick; external collar; 971. external groove; 972. hoop; 973. rod groove; 98. button;
10. table board assembly; 101. table board joint; 102. table rod; 103. side sleeve; 104. catcher; 105. table board; 106. side plate.

### DETAILED DESCRIPTION OF THE INVENTION

It should be noted that the embodiments in the present application and the features in the embodiments may be combined with each other, provided that there is no conflict. The present disclosure is described in detail below with reference to the accompanying drawings and in conjunction with embodiments.

In order to enable the skilled in the art to better understand the solutions of the present disclosure, the technical solutions in the embodiments of the present disclosure will be described clearly and completely below in connection with the drawings in the embodiments of the present application, and it will be apparent that the embodiments described herein are merely some, not all of the embodiments of the present application. Based on the embodiments of the present disclosure, all other embodiments obtained by those of ordinary skill in the art without creative work should fall within the scope of the present disclosure.

### Embodiment 1

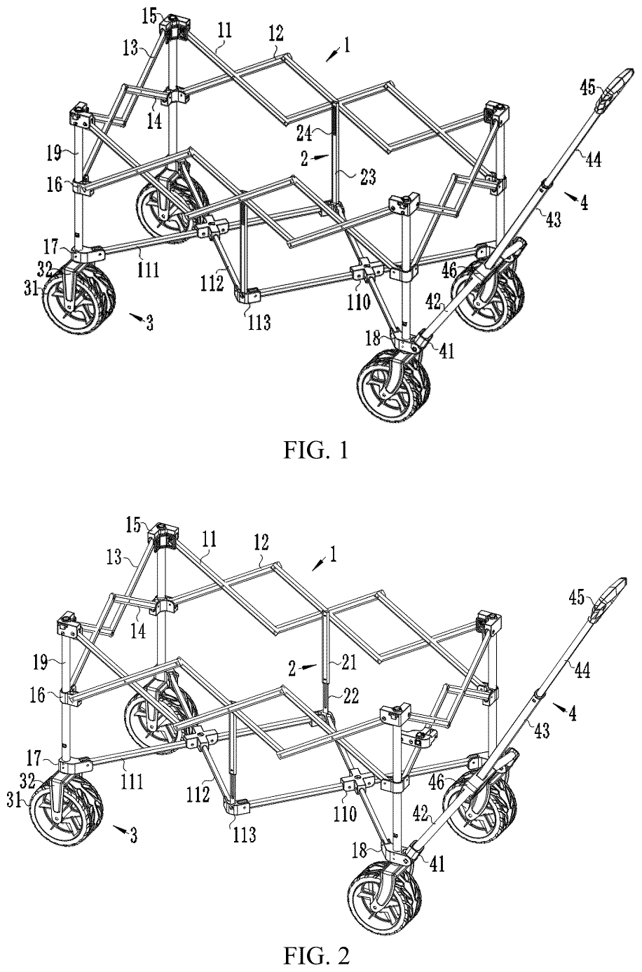

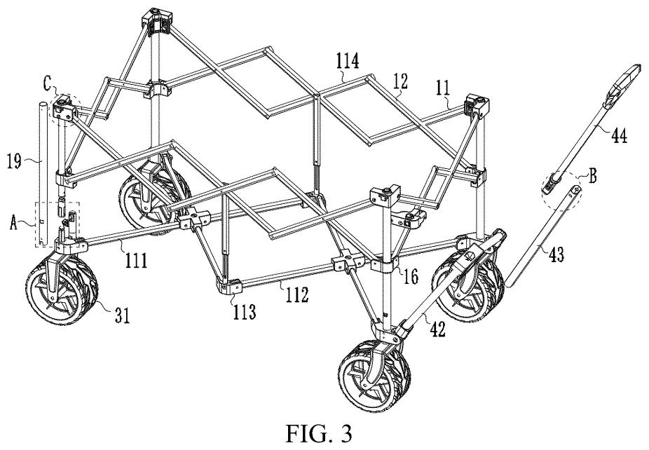

This embodiment describes the structure and principle of the expandable folding cart. Specifically:
as shown in FIGS. 1-3, the present disclosure provides an expandable folding cart, comprising a frame assembly 1, which is a basic structure of the cart and provides necessary support for the cart;
the frame assembly 1 comprises four side columns 19, which are distributed around the cart, thereby limiting the bearing range of the cart; top blocks 15 are fixedly mounted at the top of the four side columns 19, middle blocks 16 are slidably mounted at the middle parts of the four side columns 19, a plurality of rods are hinged to the middle blocks 16 and top blocks 15, and the rods constitute the overall frame of the cart, specifically:
as shown in FIGS. 1-3, upper side rods 11 are hinged to the top blocks 15 in an advancing direction of the cart and can be rotated vertically along the top blocks 15, and also lower side rods 12 are hinged to the middle blocks 16 in the advancing direction of the cart and can be rotated vertically along the middle blocks 16, and the lower side rods 12 and the upper side rods 11 are hinged to each other in the middle at first hinged points which are defined for convenience of description, so that the upper side rods 11 and the lower side rods 12 can rotate vertically around the first hinged points and drive the middle blocks 16 to slide on the side columns 19;
also, ends of the upper side rods 11 and the lower side rods 12 away from the side columns 19 are hinged to middle rods 114, the two ends of the middle rods 114 are hinged to the side rods, and the two middle rods 114 in each group are hinged to each other in a middle at second hinged point which is defined for convenience of description, so that the two middle rods 114 can rotate vertically around the second hinge points;
in the present disclosure, the upper side rods 11 and the lower side rods 12 that are hinged to each other are defined as the side rod groups, and the middle rods 114 that are hinged to each other are defined as a middle rod group, so that the cart in this embodiment consists of two side rod groups and one middle rod group, forming three crosses; and in the process of sliding the middle blocks 16 along the side columns 19, the three crosses are adapted to unfolding to form a complete cart, and the three crosses are adapted to folding for easy storage.

Referring to FIGS. 1-3 again, side upper rods 13 are hinged to the top blocks 15 in a direction perpendicular to the advancing direction of the cart, and side lower rods 14 are hinged to the middle blocks 16 in a direction perpendicular to the advancing direction of the cart; two sets of side upper rods 13 and two sets of side lower rods 14 are provided, and an end of a side upper rod 13 is hinged to an end of a side lower rod 14 in another set; also, adjacent side upper rods 13 and side lower rods 14 in the two groups are hinged in the middle, so that the side upper rods 13 and the side lower rods 14 can rotate in a vertical direction and are folded or unfolded simultaneously as the middle blocks 16 slide on the side columns 19;
also, bottom left blocks 17 are fixedly mounted at the bottom of the side columns 19 on the left, and bottom right blocks 17 are fixedly mounted at the bottom of the side columns 19 on the right, and the bottom left blocks 17 and the bottom right blocks 18 are hinged to bottom side rods 111, and the bottom side rods 111 are adapted to rotating vertically along the bottom left blocks 17 (or the bottom right blocks 18);
and, bottom middle blocks 110 are hinged to the parts of the bottom side rods 111 away from the side columns 19, and each bottom middle block 110 has four cross-shaped joint points; that is, in addition to the parts of the bottom middle block 111 hinged to the bottom side rods 111, the other two hinged parts of the bottom middle block 110 are also hinged to the bottom middle rods 112. For the convenience of illustration, the structure composed of two bottom side rods 111, one bottom middle block 110 and two bottom middle rods 112, hinged to each other, is defined as a bottom rod group, and the bottom rod group can be folded and unfolded during the vertical movement of the bottom middle block 110;
in this embodiment, two bottom rod groups are provided, and bottom side blocks 113 are hinged between the two bottom rod groups and are hinged to the bottom middle rods 112 in the two bottom rod groups respectively and by the bottom side blocks 113, the two bottom rod groups are into a whole.

In order to improve the stability of the frame assembly 1, as shown in FIG. 2, tie rod assemblies 2 are arranged between the second hinged points and the bottom side blocks 113, each tie rod assembly 2 comprises an upper tie rod 21 fixedly mounted at the second hinged point and a lower tie rod 22 fixedly mounted at the bottom side block 113, the upper tie rod 21 and the lower tie rod 22 are vertically arranged, each upper tie rod 21 is internally provided with a tie rod groove (not shown) with an open bottom so that the lower tie rod 22 can slide in a vertical direction in the upper tie rod 21 to adapt to the folding and unfolding of the frame assembly 1;
also, each lower tie rod 22 is provided with a waist groove (not shown) in a vertical direction, and a pin (not shown) is fixedly mounted on each upper tie rod 21; the pins can slide in the waist grooves to limit the sliding position of the lower tie rods 22, so as to prevent the lower tie rods 22 from going out of the upper tie rods 21, and when the cart is folded, the lower tie rods 22 are completely received in the upper tie rods 21, so that the height of the cart does not change after the cart is folded.

It should be noted that the tie rod assembly 2 may also be arranged in the form of a single tie rod, as shown in FIG. 1, that is, a single tie rod 23 is arranged between the second hinged point and the bottom side block 113, and a long waist groove 24 is formed at the upper end of the single tie rod 23, and a spring pin (not shown) is fitted at the second hinged point. In this way, by pressing the spring pin, the single tie rod 23 can be popped out and the cart can be unfolded and when the pin is pressed again, the spring pin is stuck in the long waist groove 24, so that the single tie rod 23 can be folded.

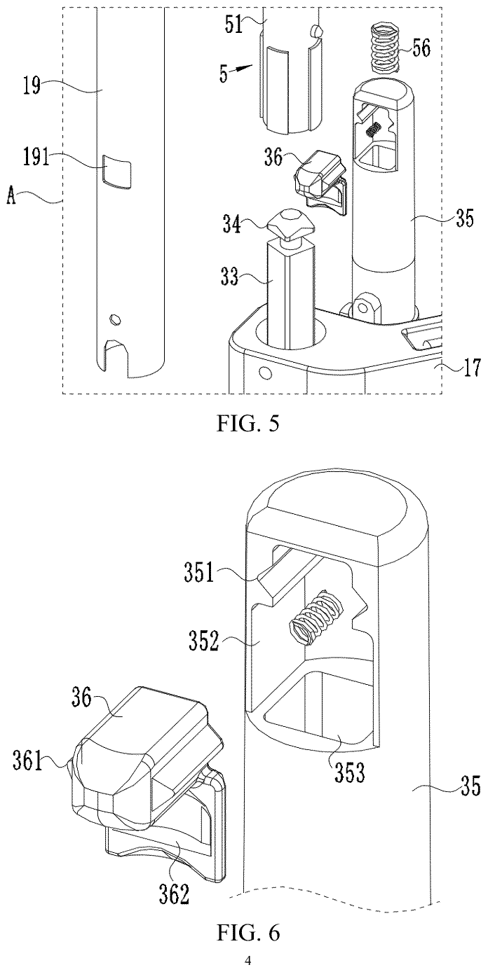

In order to enable the cart to move, as shown in FIGS. 2 and 5-6, a wheel assembly 3 is arranged at the bottom of each of the four side columns 19, the wheel assembly 3 comprises a lower inner rod 35 fixedly mounted at the bottom of the side column 19, a matching groove 353 which goes through at the bottom is formed in the interior of the lower inner rod 35 in a lengthwise direction, the matching groove 353 is configured as a square, and an insert rod 33 is slidably arranged in the interior of the matching groove 353; in this, way the insert rod 33 can rotate but not rotate in the matching groove 353;
a wheel frame 32 is mounted at the bottom of the insert rod 33 by means of a bearing and a wheel 31 is mounted on the wheel frame 32 and is configured to drive the cart to move;
in order to fix the insert rod 33, as shown in FIGS. 5-6, the lower inner rod 35 is provided with an insert groove 352 at an upper end of the matching groove 353, the insert groove 352 is open on a side, an insert block 36 is inserted in the interior of the insert groove 352, a horizontal chute 351 is arranged at an upper end of the insert groove 352, and a boss 361 is arranged on a side of the insert block 36; in this way, the insert block 36 can slide in or out of the insert groove 352 with the cooperation of the chute 351 and the boss 361;
also, a hole 191 is formed in a side of the side column 19 and from the hole 191, the insert block 36 can slide out; and the boss 361 is supported at the hole 191 to facilitate the fixing of the insert block 36;
and a receiving groove 362 is formed at the bottom of the insert block 36; it should be noted that an elastomer is fixedly mounted between the insert block 36 and the insert groove 35, the elastomer is adapted to pushing the insert block 36 to protrude the hole 191 in an initial state to fix the insert block, and the elastomer, when pressed, is adapted to driving the insert block 36 to slide into the interior of the hole 191; an upper end of the insert rod 33 is provided with a plug 34, the plug 34 is adapted to the receiving groove 362, and a step (not shown) is arranged at the bottom of the receiving groove 362; and a gap matched with the step is provided between the plug 34 and the insert rod 33, and when the insert rod 33 needs to be mounted, the insert block 36 is pressed, so that the insert block 36 slides into the side column 19 and then pushes the insert rod 33 upward until the plug 34 is located in the position of the receiving groove 362, and then the insert block 36 is released and returns under the action of the elastomer, and the insert rod 33 is fixed in the receiving groove 362;
when the insert rod 33 needs to be removed, the insert rod 33 can be removed by pressing the insert block 36 again, thus realizing the fast dismantling of the insert rod 33 and further realizing the fast dismantling of the wheel 31; in this way, the frame assembly 1 can be folded into a smaller size, thereby realizing a smaller packaging size of the cart.

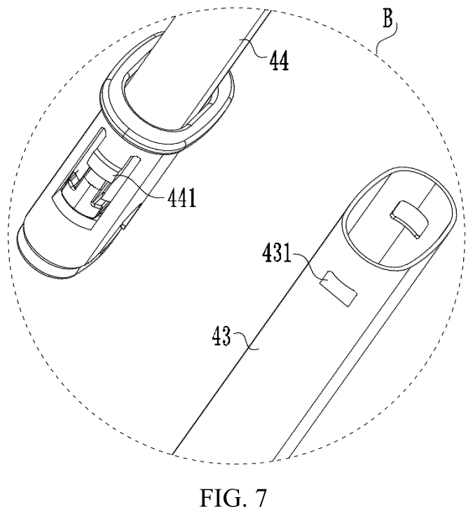

In order to facilitate the operation of a worker, as shown in FIGS. 1-3 and FIG. 7, a handle assembly 4 is mounted on the bottom right blocks 18 and by the handle assembly 4, the worker can push the cart; the handle assembly 4 comprises hinging blocks 41 hinged to the bottom right blocks 18, and connecting rods 42 are hinged to the hinging blocks 41; in this way, the connecting rods 42 can rotate flexibly with the help of the two hinged points;
also, ends of the connecting rods 42 away from the hinged blocks 41 are hinged to a junction block 46, a lower handle 43 is fixedly mounted on the junction block 46, an upper handle 44 is mounted on the lower handle 43, and a grip 45 is fixedly mounted on the upper handle; in this way, the worker can hold the grip 45 with hands to push the cart to move, thus achieving the effect of labor saving; moreover, since the connecting rods 42 and the lower handle 43 are hinged, when the cart is folded, the handle assembly 4 can also be folded and closed, thus further reducing the size of the cart;
and an upper end of the lower handle 43 is provided with a cavity (not shown), and the upper handle 44 can slide in the cavity, so that the upper handle 44 can slide into the lower handle 43 to be received in the lower handle 44; also, the upper handle 44 is provided with an elastic sheet 441, and a side of the lower handle 43 is provided with a fixing hole 431, so that the elastic sheet 441 can be caught in the fixing hole 431 to fix the upper handle 44 which is in a stretching sate; to retract the upper handle 44, the elastic sheet 441 is pressed so that the elastic sheet 441 enters the interior of the lower handle 43, and then the upper handle 44 can slide smoothly into the cavity of the lower handle 43.

### Embodiment 2

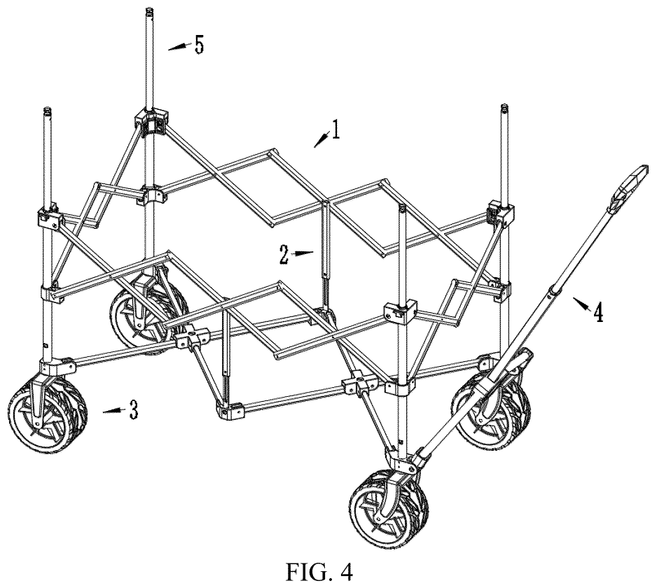

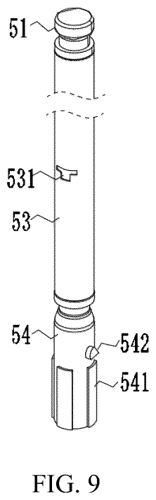

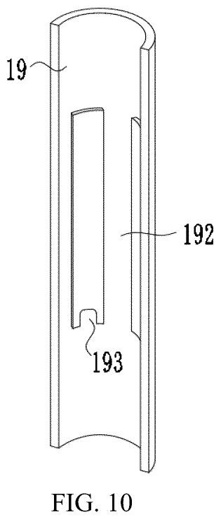

When in use, the cart often needs to be used in some special occasions, such as as a temporary sales point, and in this case, a canopy is needed to block the sun or prevent rain, and the temporary addition of the canopy often requires workers to use additional rods to fix the canopy, thereby increasing the difficulty of on-site operation;
to solve the above problems, as shown in FIGS. 4-5 and 8-10, an expansion assembly 5 is arranged at the top of the cart. The expansion assembly 5 is configured to temporarily add additional accessories to the cart to realize the application of the cart in different scenarios;
the expansion assembly 5 comprises expansion rods 53 slidably arranged in the interior of the side columns 19, a limit rod 54 is mounted at a lower end of each expansion rod 53, and a spring 56 is fixedly mounted on the limit rod 54 and an upper end of the lower inner rod 35; in this way, the expansion rods 53 can slide in the interior of the side columns 19 and return under the action of the springs 56, and in the initial state, the springs 56 are extended and push the expansion rods 53 out of the side columns 19;
also, a press head 51 is fixed on the top of each expansion rod 53 and by the press head 51, the worker can spin the expansion rod 53, so that the expansion rod 53 can stretch out or retract in the side column 19;
in order to fix the expansion rod 53 in a retracted state, as shown in FIGS. 9-10, a plurality of guide blocks 541 are arranged uniformly at the bottom of each limit rod in a circumferential direction, a plurality of convex blocks (not shown) are also uniformly arranged in the interior of each side column in a circumferential direction, a plurality of guide grooves 192 are thus formed between the plurality of convex blocks, and the guide grooves 192 are matched with the guide blocks 541; in this way, the extension rods 53 can slide in the interior of the side columns 19 with the cooperation of the guide blocks 541 and the guide grooves 192;
also, a limit groove 193 is formed at the bottom of a convex block, and the limit rod 54 is fixedly provided with a limit portion 542 arranged above the guide block 541 and the limit portion 542 is matched with the limit groove 193; in this way, the limit portion 542 can be caught in the limit groove 193, so as to limit and fix the expansion rod 53;
in summary, in the initial state, under the action of the springs 56, the expansion rods 53 stretch out of the side columns 19 to facilitate the temporary addition of additional accessories to the cart; when the expansion rod 53 needs to retract, the press head 51 is pressed first so that the expansion rod 53 moves down until the guide blocks 541 slides into the guide grooves 192.
the expansion rod 53 is further pushed to move down so that the upper ends of the guide blocks 541 are at the lower ends of the convex blocks, and then the worker turns the press head 51 and the expansion rod 53 turns slightly correspondingly until the limit portion 542 is below the limit groove 193, at which time the spring 56 also turns slightly, but does not affect the performance of the spring 56;
then, the worker releases the press head 51 and under the action of the restoring force of the spring 56, the limit portion 542 springs into the limit groove 193 and limits and fixes the expansion rod 53 in a retracted state;
when the expansion rod 53 is in need, the press head 51 is pressed and turned again so that the guide blocks 541 slide to be in line with the guide grooves 192, and then the expansion rod 53 stretches out under the action of the spring 56.

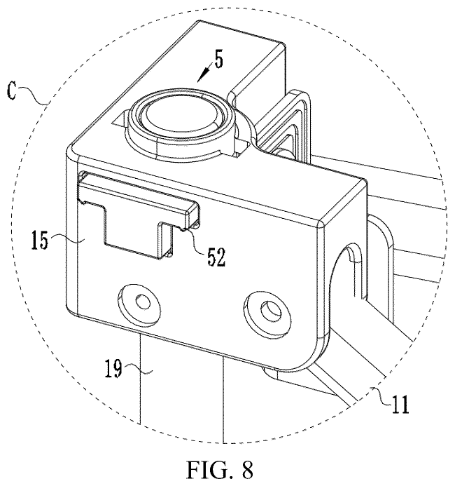

In order to fix the expansion rod 53 in the stretching state, as shown in FIGS. 8-9, a fastening groove 531 is formed in the expansion rod 53, and a fastening hole (not shown) is also formed in a side of the top block 15, and a fastening block 52 is fastened in the fastening hole; the fastening block 52 is adapted to penetrating the side column 19 and going deep into the fastening groove 531; in this way, when stretching out, the expansion rod 53 is fixed with the cooperation of the fastening block 52 and the fastening groove 531.

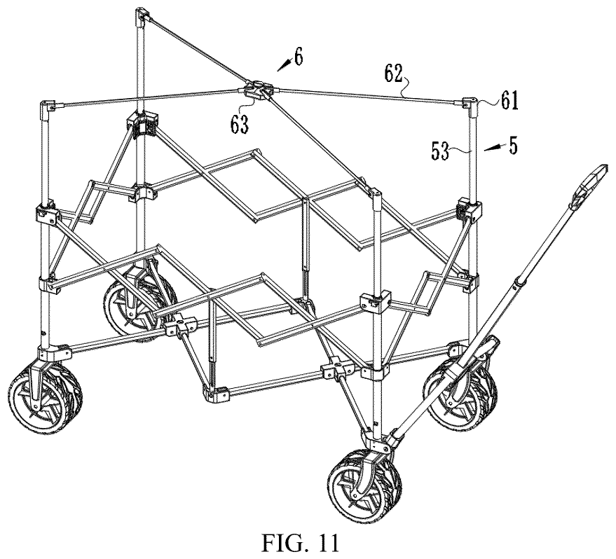

In this embodiment, the following application scenarios of the expansion rods 53 are provided. Specifically:
referring to FIG. 11, a specific structure for addition of a canopy assembly 6 to the top of the expansion rods 53 is illustrated. The canopy assembly comprises connecting sleeves 61 sleeved at the top of the expansion rods 53, each of the four connecting sleeves 61 is hinged to a canopy rod 62, and the other ends of the four canopy rods 62 are jointly hinged to canopy connecting block 63. In this way, a structure for mounting a canopy is formed at the top of the expansion rods 53, so that the cart can be used in various scenarios such as outdoor sales.

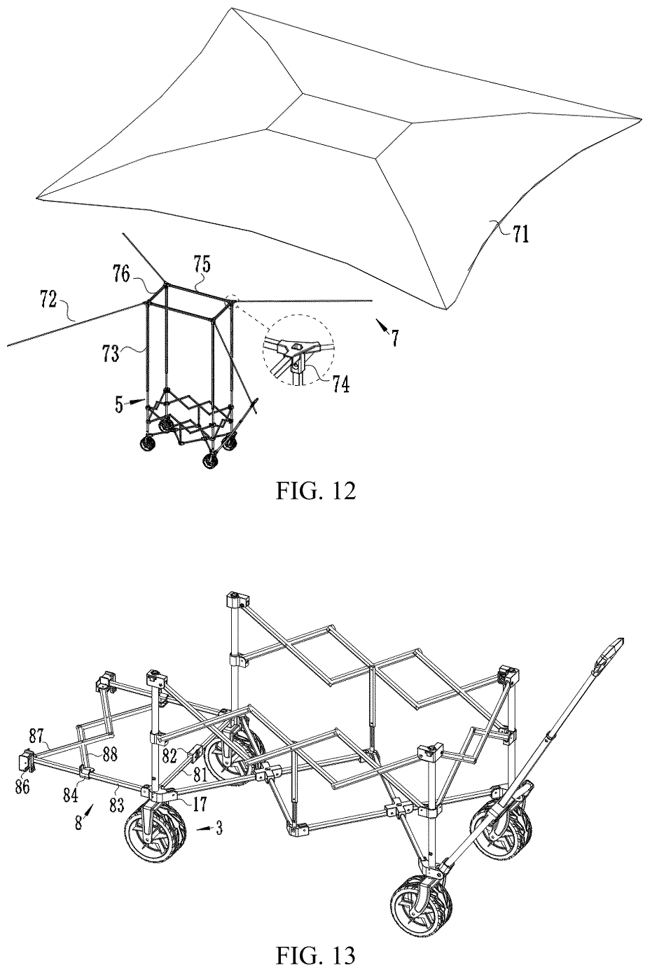

Referring to FIG. 12, a specific structure for addition of an awning assembly 7 to the top of the expansion rods 53, and the awning assembly 7 can provide a greater area of protection than the canopy assembly 6. The awning assembly 7 comprises extension rods 73 sleeved on the expansion rods 53, and an awning connecting block 74 is sleeved at the top of each extension rod 7 and has three connecting ends, wherein an awning stick 72 is inserted at the outer one of the connecting ends, and an awning 71 is mounted on the awning sticks 72; in this way, the area within the coverage of the cart can be better protected by the expanded awning 71;
also, in order to ensure the stability of the awning assembly 7, a long awning rod 75 and a short awning rod 76 are respectively inserted at the other two connecting ends, and the long awning rod 75 and the short awning rod 76 are configured to connect and fix the four connecting ends; in this way, the stability of the awning assembly 7 can be ensured.

### Embodiment 3

In use of the cart, for some goods which are relatively long, the original cart structure can not support the goods better and in this case, additional extension rods are usually required to achieve the purpose, and the extension rods need to be mounted and disassembled by workers, thereby increasing the burden of workers;
in order to solve the above problem, as shown in FIG. 13, an extension assembly 8 is mounted on the bottom left blocks 17 which is configured to extend the cart for carrying longer goods; the extension assembly 8 comprises cross bars 81 hinged to the bottom left blocks 17, the cross bars 81 are arranged in a direction perpendicular to an advancing direction of the cart, and the two cross bars 81 are jointly hinged to a cross block therebetween; in this way, the cross block 82 can move in a vertical direction to drive the two cross bars 81 to fold or unfold together with the cart;
in this embodiment, because the cart is supported by two cross bars 81, the side upper rod 13 and the side lower rod 14 on this side, which are hinged to each other, are removed, thus simplifying the structure of the cart;
also, extension rods 83 are hinged to the bottom left blocks 17 in the advancing direction of the cart and are adopted to rotating in a vertical direction, so as to get close to the side columns 19 for folding, or unfold to a horizontal direction to load the long goods;
referring to FIG. 13 again, an end block 86 is arranged at an end of each extension rod 83, an extension block 84 is slidably arranged at the middle position on each extension rod 83, first folding rods 87 are also hinged to the end blocks 86, second folding rods 88 are hinged to the extension blocks 84, the two first folding rods 87 are hinged to each other at the other end, and the first folding rods 87 and the second folding rods 88 are hinged to each other in the middle; in this way, the two extension rods 83 can be folded for storage and unfolded for loading long goods.

### Embodiment 4

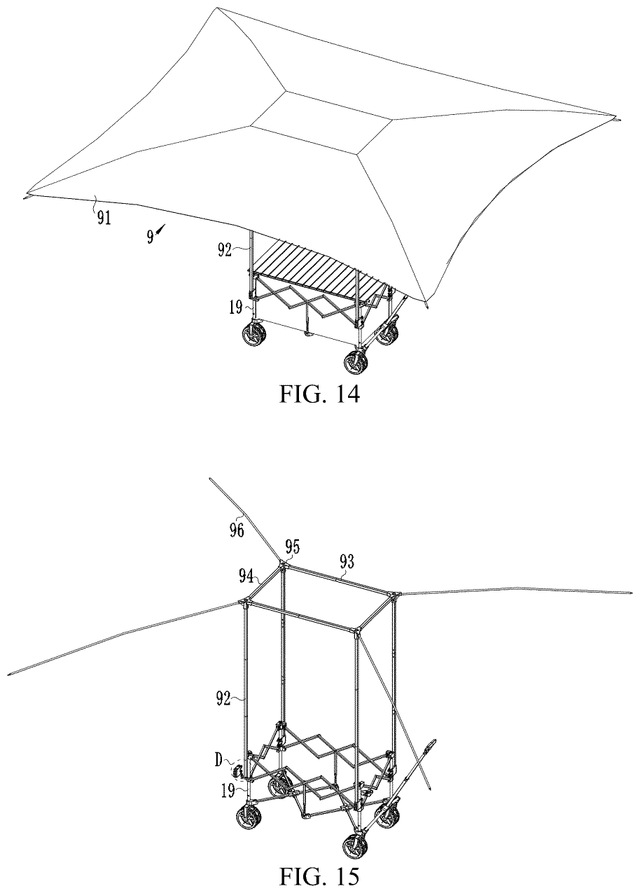

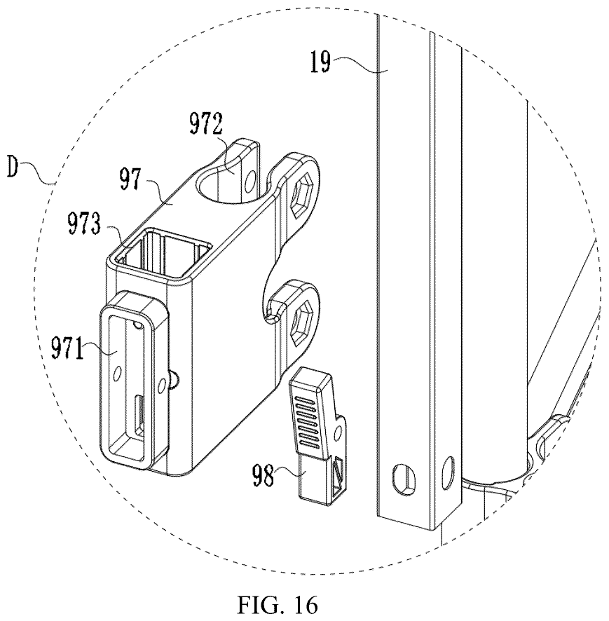

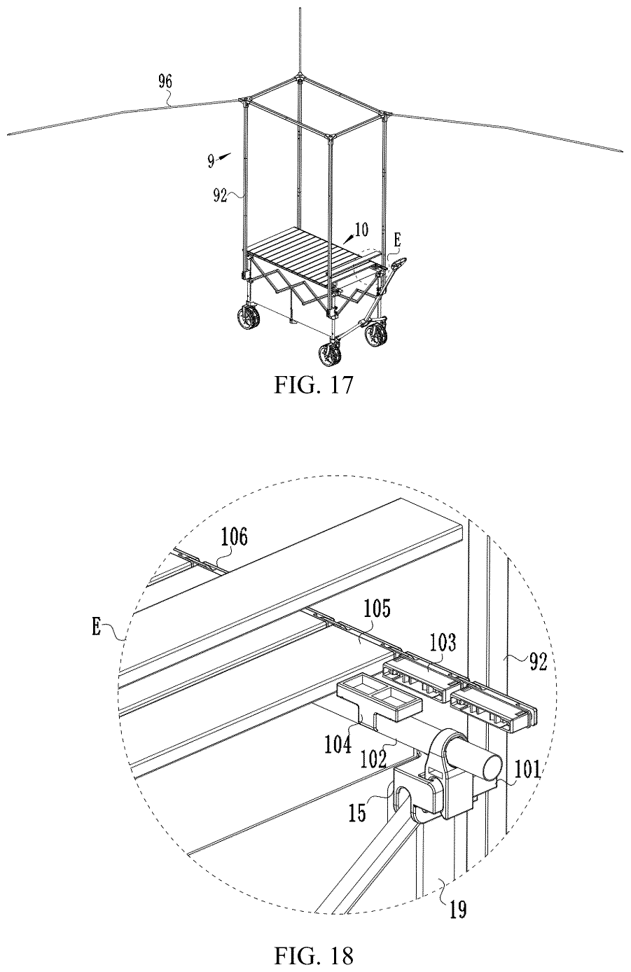

This embodiment describes the structure and principle of the expandable folding cart to expand a table board and an external awning, specifically:
as shown in FIGS. 14 and 17, an external assembly 9 is arranged at the upper ends of the side columns 19 and is configured to add an awning on the top of the cart; also, a table board assembly 10 is mounted on the side columns 19 and is configured to improve the loading capacity of the cart, so as to facilitate the operation of the worker with the table board assembly 10 and prevent the fall of smaller objects. In this way, the cart can be adapted to different application scenarios;
as shown in FIGS. 14-16, the external assembly 9 comprises external collars 97 arranged on the side columns 19, each external collar 97 is provided with an arc hoop 972, and the external collars 97 are connected to any position on the side columns by the hoops 972 and fixed by fasteners;
also, each external collar 97 is vertically provided with a through rod groove 973 in which an external rod 92 is inserted slidably, an external groove 971 is formed in a side of each external collar 97, the external grooves 971 are connected with the rod grooves 973, a button 98 is turnably arranged in each external groove 971, and torsion springs (not shown) are arranged between the buttons 98 and the external grooves 971; thus, in a free state, one end of the button 98 is held on the surface of the external rod 92 under the action of the torsion spring and fixes the external rod 92, and when the worker presses the button 98, the external rod 92 is released from the holding end of the button 98, so that the external rod 92 can slide freely in the external groove 971 and adjusts its position;
and, an external connecting block 95 is sleeved on the top of each external rod 92, the external connecting block 95 has three external connecting ends, wherein an external stick 96 is inserted at the outer one of the external connecting ends, and an external awning 91 is mounted on the external sticks 96; in this way, the area within the coverage of the cart can be better protected by the expanded external awning 91;
also, in order to ensure the stability of the external assembly 9, a long connecting rod 93 and a short connecting rod 94 are respectively inserted at the other two external connecting ends, and the long connecting rod 93 and the short connecting rod 94 are configured to connect and fix the four external connecting ends; in this way, the stability of the external assembly 9 can be ensured.

As shown in FIGS. 17-18, the table board assembly 10 comprises table board joints 101 fastened to the top blocks 15, an upper end of each table board joint 101 is provided with a ring (not shown), and table rods 102 are inserted in the rings and arranged in the advancing direction of the cart;
also, a plurality of catchers 104 are uniformly arranged on each table rod 102 in a lengthwise direction, and a table board 105 is fastened in each catcher; it should be understood that the bottom of the table boards 105 is arranged in a U-shape, so that the catchers 104 can be fastened to the bottom of the table boards 105 to limit the position of the table boards 105;
in this embodiment, the catchers 104 are made of a nylon material, which can better adapt to the bottom shape of the table boards 105, thereby firmly fixing the table boards 105;
in order to connect the multiple table boards 105 as a whole and further strengthen the stability of the table boards 105, referring to FIG. 18 again, a side of each table board 105 is fitted in a side sleeve 103, each side sleeve 103 is fixedly provided with a side plate 106 away from the table board 105, and the multiple side plates 106 are hinged to each other; in this way, the multiple table boards 105 are connected by the movable side sleeves 103, thus strengthening the stability of the table boards 105 to adapt to different application scenarios of the cart.

The above are only preferred embodiments of the present disclosure and are not intended to limit the present disclosure. For those skilled in the art, the embodiments of the present disclosure may have various modifications and changes. Any modification, equivalent replacement, improvement, etc. made within the spirit and principle of the present disclosure shall fall within the scope of the present disclosure.

What is claimed is:

1. An expandable folding cart, characterized by comprising:
four side columns (19), a top block (15) being fixedly arranged at an upper end of each side column (19), a middle block (16) being slidably arranged at a middle part of each side column (19);
upper side rods (11) hinged to the top blocks (15);
lower side rods (12) hinged to the middle blocks (16), the lower side rods (12) and the upper side rods (11) being hinged to each other in the middle;
middle rod groups, each middle rod group comprising two mutually hinged middle rods (114), the middle rod groups being respectively hinged to the upper side rods (11) and the lower side rods (12), the two middle rods (114) being hinged in the middle and forming a second hinged point;
bottom left blocks (17) hinged to the bottom of the side columns (19) on one side;
bottom right blocks (18) hinged to the bottom of the side columns (19) on the other side;
two bottom rod groups hinged to the bottom left blocks (17) and the bottom right blocks (18) respectively, the other ends of the bottom rod groups being hinged to bottom side blocks (113);
wheel assemblies (3) detachably mounted at the bottom of the side columns (19);
tie rod assemblies (2) mounted between the bottom side blocks (113) and the second hinged points, each tie rod assembly (2) comprising:
an upper tie rod (21) fixedly mounted at the second hinged point and a lower tie rod (22) fixedly mounted at the bottom side block (113), the upper tie rod (21) and the lower tie rod (22) being vertically arranged, the upper tie rod (21) being internally provided with a tie rod groove with an open bottom;
the lower tie rod (22) being provided with a waist groove in a vertical direction, a pin being fixedly mounted on the upper tie rod (21).

2. An expandable folding cart, characterized by comprising:
four side columns (19), a top block (15) being fixedly arranged at an upper end of each side column (19), a middle block (16) being slidably arranged at a middle part of each side column (19);
upper side rods (11) hinged to the top blocks (15);
lower side rods (12) hinged to the middle blocks (16), the lower side rods (12) and the upper side rods (11) being hinged to each other in the middle;
middle rod groups, each middle rod group comprising two mutually hinged middle rods (114), the middle rod groups being respectively hinged to the upper side rods (11) and the lower side rods (12), the two middle rods (114) being hinged in the middle and forming a second hinged point;
bottom left blocks (17) hinged to the bottom of the side columns (19) on one side;
bottom right blocks (18) hinged to the bottom of the side columns (19) on the other side;
two bottom rod groups hinged to the bottom left blocks (17) and the bottom right blocks (18) respectively, the other ends of the bottom rod groups being hinged to bottom side blocks (113);
wheel assemblies (3) detachably mounted at the bottom of the side columns (19);
tie rod assemblies (2) mounted between the bottom side blocks (113) and the second hinged points, each tie rod assembly (2) comprising:
a single tie rod (23) arranged between the second hinged point and the bottom side block (113), an upper end of the single tie rod (23) being provided with a long waist groove (24), a spring pin being fitted at the second hinged point.

3. The expandable folding cart according to claim 1, characterized in that an external assembly (9) is arranged at the upper ends of the side columns (19) and comprises external collars (97) arranged on the side columns (19), and each external collar (97) is provided with an arc hoop (972);
each external collar (97) is vertically provided with a through rod groove (973) in which an external rod (92) is inserted slidably, an external groove (971) is formed in a side of each external collar (97), the external grooves (971) are connected with the rod grooves (973), a button (98) is turnably arranged in each external groove (971), and torsion springs are arranged between the buttons (98) and the external grooves (971);
an external connecting block (95) is sleeved on the top of each external rod (92), an external stick (96) is inserted in each external connecting block (95), and an external awning (91) is mounted on the external sticks (96);
long connecting rods (93) and short connecting rods (94) are inserted in the external connecting blocks (95).

4. The expandable folding cart according to claim 1, characterized in that each of the wheel assembly (3) comprises a lower inner rod (35) mounted at the bottom of the side column (19), a matching groove (353) which goes through at the bottom is formed in the interior of the lower inner rod (35) in a lengthwise direction, the matching groove (353) is configured as a square, and an insert rod (33) is slidably arranged in the interior of the matching groove (353);
a wheel frame (32) is mounted at the bottom of the insert rod (33) by means of a bearing, and a wheel (31) is mounted on the wheel frame (32).

5. The expandable folding cart according to claim 4, characterized in that the lower inner rod (35) is provided with an insert groove (352) at an upper end of the matching groove (353), the insert groove (352) is open on a side, an insert block (36) is inserted in the interior of the insert groove (352), a horizontal chute (351) is arranged at an upper end of the insert groove (352), and a boss (361) is arranged on a side of the insert block (36);
a hole (191) is formed in a side of the side column (19), a receiving groove (362) is formed at the bottom of the insert block (36), an elastomer is mounted between the insert block (36) and the insert groove (352), the elastomer is adapted to pushing the insert block (36) to protrude the hole (191) in an initial state, and the elastomer, when pressed, is adapted to driving the insert block (36) to slide into the interior of the hole (191);
an upper end of the insert rod (33) is provided with a plug (34), the plug (34) is adapted to the receiving groove (362), and a step is arranged at the bottom of the receiving groove (362).

6. The expandable folding cart according to claim 5, characterized in that an expansion assembly (5) is arranged at the upper ends of the side columns (19), the expansion assembly (5) comprises expansion rods (53) slidably arranged in the interior of the side columns (19), a limit rod (54) is mounted at a lower end of each expansion rod (53), and a spring (56) is mounted on the limit rod (54) and an upper end of the lower inner rod (35);
a plurality of guide blocks (541) are arranged uniformly at the bottom of each limit rod (54) in a circumferential direction, a plurality of convex blocks are uniformly arranged in the interior of each side column (19) in a circumferential direction, a plurality of guide grooves (192) are formed between the plurality of convex blocks, and the guide grooves (192) are matched with the guide blocks (541);
a limit groove (193) is formed at the bottom of a convex block, and the limit rod (54) is fixedly provided with a limit portion (542) arranged above the guide block (541), and the limit portion (542) is matched with the limit groove (193).

7. The expandable folding cart according to claim 6, characterized in that a canopy assembly (6) is arranged at the top of the expansion rods (53), the canopy assembly (6) comprises connecting sleeves (61) sleeved at the top of the expansion rods (53), and each of the four connecting sleeves (61) is hinged to a canopy rod (62), and the other ends of the four canopy rods (62) are jointly hinged to a canopy connecting block (63).

8. The expandable folding cart according to claim 6, characterized in that an awning assembly (7) is arranged at the top of the expansion rods (53), the awning assembly (7) comprises extension rods (73) sleeved on the expansion rods (53), an awning connecting block (74) is sleeved at the top of each extension rod (73) and has three connecting ends, wherein an awning stick (72) is inserted at the outer one of the connecting ends, and an awning (71) is mounted on the awning sticks (72);
a long awning rod (75) and a short awning rod (76) are inserted at the other two connecting ends, and the long awning rod (75) and the short awning rod (76) are configured to connect and fix the four connecting ends.

9. The expandable folding cart according to claim 1, characterized in that an extension assembly (8) is mounted on the bottom left blocks (17), the extension assembly (8) comprises cross bars (81) hinged to the bottom left blocks (17), the cross bars (81) are arranged in a direction perpendicular to an advancing direction of the cart, and the two cross bars (81) are jointly hinged to a cross block (82) therebetween;
extension rods (83) are hinged to the bottom left blocks (17) in the advancing direction of the cart and adopted to rotating in a vertical direction;
an end block (86) is arranged at an end of each extension rod (83), an extension block (84) is slidably arranged at the middle position on each extension rod (83), first folding rods (87) are hinged to the end blocks (86), second folding rods (88) are hinged to the extension blocks (84), the two first folding rods (87) are hinged to each other at the other end, and the first folding rods (87) and the second folding rods (88) are hinged to each other in the middle.

10. The expandable folding cart according to claim 2, characterized in that a table board assembly (10) is mounted on the top blocks (15), the table board assembly (10) comprises table board joints (101) fastened to the top blocks (15), an upper end of each table board joint (101) is provided with a ring, and table rods (102) are inserted in the rings;
a plurality of catchers (104) are uniformly arranged on each table rod (102) in a lengthwise direction, and a table board (105) is fastened in each catcher (104);
a side of each table board (105) is fitted in a side sleeve (103), each side sleeve (103) is provided with a side plate (106) away from the table board (105), and the side plates (106) are hinged to each other.

11. The expandable folding cart according to claim 2, characterized in that an external assembly (9) is arranged at the upper ends of the side columns (19) and comprises external collars (97) arranged on the side columns (19), and each external collar (97) is provided with an arc hoop (972);
each external collar (97) is vertically provided with a through rod groove (973) in which an external rod (92) is inserted slidably, an external groove (971) is formed in a side of each external collar (97), the external grooves (971) are connected with the rod grooves (973), a button (98) is turnably arranged in each external groove (971), and torsion springs are arranged between the buttons (98) and the external grooves (971);
an external connecting block (95) is sleeved on the top of each external rod (92), an external stick (96) is inserted in each external connecting block (95), and an external awning (91) is mounted on the external sticks (96);
long connecting rods (93) and short connecting rods (94) are inserted in the external connecting blocks (95).
